(19) United States
(12) Patent Application Publication
(10) Pub. No.: US 2026/0003368 A1
(43) Pub. Date: Jan. 1, 2026

(54) REAL-TIME ROBOT-MOUNTED SPILL DETECTION SYSTEM WITH MULTI-CAMERAS UTILIZING DEEP LEARNING

(71) Applicant: LAWRENCE TECHNOLOGICAL UNIVERSITY, Southfield, MI (US)

(72) Inventors: Chan-Jin Chung, Troy, MI (US); Devson Butani, Hazel Park, MI (US)

(21) Appl. No.: 19/303,518

(22) Filed: Aug. 19, 2025

Related U.S. Application Data
(60) Provisional application No. 63/666,483, filed on Jul. 1, 2024.

(51) Int. Cl. G05D 1/648; G05D 101/15; G05D 105/10; G05D 109/10; G05D 111/10; G06V 10/82; G06V 20/56; G08B 21/02

(52) U.S. Cl. CPC G05D 1/6486; G06V 10/82; G06V 20/56; G08B 21/02; G05D 2101/15; G05D 2105/10; G05D 2109/10; G05D 2111/14

(57) ABSTRACT

A system for detecting and addressing a spill is provided. The system includes an imaging device coupled to a mobile robot, a controller including a processor and memory including an interface module that receives a plurality of images, including infrared thermal and RGB images, from the imaging device, an artificial intelligence (AI) module for evaluating the plurality of images to determine a presence or absence of the spill and provides an output to the alert module when the spill has occurred. The memory includes an alert module that provides an alert of the spill, marks an area of the spill, or initiates a cleanup of the spill. The AI module evaluates the thermal and RGB images together to train and inference on the mobile robot in real-time using a voting module that executes an ensemble algorithm, or secondary layer based on the separate outputs to generate a single output.

### CROSS-REFERENCE TO RELATED APPLICATIONS

This application claims the benefit of U.S. Provisional Application No. 63/666,483, filed on Jul. 1, 2024. The entire disclosure of the above application is incorporated herein by reference.

### FIELD

The present technology relates to autonomous spill detection systems for applications in commercialized environments and, more particularly, to robotic systems for detecting spills and preventing slip and falls.

### INTRODUCTION

This section provides background information related to the present disclosure which is not necessarily prior art.

Slip and fall accidents caused by water spills in public areas such as commercial establishments, retail stores, restaurants, and other facilities where people gather pose financial and reputation risks for establishment owners. Such accidents may result in injuries, particularly among older individuals who may be more susceptible to falls and related complications. The consequences of these accidents may extend beyond personal injury to include liability concerns for property owners and operators. Water spills may occur frequently in commercial environments due to various factors including beverage spills, cleaning activities, plumbing leaks, and weather-related moisture.

Solutions for detecting and addressing water spills may have limitations that reduce effectiveness in preventing slip and fall accidents. Certain approaches may rely on human intervention and manual processes, which may introduce delays in detection and response times. These manual systems may depend on staff members to visually identify spills during routine inspections or rely on customers to report hazardous conditions. The reliance on human observation may be problematic as staff members may not be present in all areas at all times, and customers may not always notice, or promptly report spills.

Certain detection systems may be ill-suited for addressing water spills in commercial environments due to their design limitations and operational constraints. Such systems may utilize wall-mounted cameras pointed at potential hazards, but these systems may lack the dynamic capabilities required for comprehensive spill detection across large areas. Other approaches may focus on detecting fluid leaks in industrial environments rather than addressing the specific challenges of liquid spill detection in commercial settings. These systems may not provide the real-time capabilities and adaptability required for detecting and responding to water spills promptly in a dynamic commercial environment.

Optical spill detection methods may rely primarily on image segmentation techniques for detecting edges and object boundaries as a primary detection method, but these approaches may have potential problems in commercial applications. Spills in places such as cafeterias or restaurants may not always be uniform puddles and may not contain adequate volumes for easy detection, making detection more difficult using segmentation approaches. In scenarios where spills may be small and spread out, they may not be registered by detection systems at all, particularly those relying solely on thermal imaging or visible light cameras. Certain environmental factors such as air conditioning systems may blow cold air onto floors, creating moisture and water condensate near vents that may be difficult to detect using conventional visible light methods.

Certain detection systems may use thermal and depth cameras to identify abnormal height with thermal gradients to classify spills, but these methods may be limited to smooth floors in well-lit environments like warehouses. These other approaches may rely more on height differences and color gradients rather than temperature variations, which may limit their effectiveness across different floor types and lighting conditions. Such systems may use color images to classify clear or colored liquids, but this approach may be insufficient for detecting transparent or semi-transparent spills that may be particularly hazardous. The limitations of these other approaches may result in missed detections or false positives that reduce the overall reliability of spill detection systems.

There may be a continuing need for a spill detection system that can promptly identify water spills and communicate information to relevant personnel or automated systems in real-time across various floor types and environmental conditions. Desirably, such a system would overcome the limitations of segmentation-based approaches that struggle with small or spread-out spills, provide enhanced detection accuracy through advanced machine learning techniques that utilize multiple imaging modalities simultaneously, and offer adaptability for different commercial environments while reducing reliance on manual intervention and human observation delays.

### SUMMARY

In concordance with the instant disclosure of the present invention, a spill detection system that can promptly identify water spills and communicate information to relevant personnel or automated systems in real-time across various floor types and environmental conditions, has surprisingly been discovered.

The present technology includes articles of manufacture, systems, machines, and processes that relate to autonomous spill detection utilizing mobile robots equipped with imaging devices and machine learning algorithms for real-time identification and response to liquid spills in commercial environments. The technology may encompass a mobile robot with a mounted imaging device including a camera for optical and thermal imaging that may capture environmental data for spill detection purposes. The systems may include a controller for machine-learning that may utilize neural networks specifically trained to evaluate images and determine the presence or absence of spill hazards. The processes may involve multiple training methodologies including ensemble algorithms with max voting, stacking ensemble approaches with additional neural network layers, and combining RGB and thermal image processing techniques that may enhance detection accuracy across various floor types and environmental conditions. The present technology may include alert systems capable of sending notifications through text messages and emails, marking devices for physically identifying detected spill areas, and cleanup mechanisms for initiating response processes upon spill detection.

In certain embodiments, a system for detecting and addressing a spill is disclosed. The system may include an imaging device that may be coupled to a mobile robot and a controller that may include a processor and a memory in communication with the processor. The memory may include an interface module, an artificial intelligence (AI) module, and an alert module that may work together to process spill detection. The interface module may receive a plurality of images from the imaging device and may provide the plurality of images to the AI module for evaluation. The AI module may receive the plurality of images from the interface module, may evaluate the plurality of images to determine a presence or an absence of the spill, and may provide an output to the alert module when the spill has occurred, while the alert module may receive the output from the AI module and may perform at least one of providing an alert of the spill, marking an area of the spill, and initiating cleanup of the spill.

In certain embodiments, a method for detecting and addressing a spill is provided. The method may include a step of providing an imaging device that may be coupled to a mobile robot and a controller that may include a processor, a memory in communication with the processor, and memory modules including an interface module, an AI module, and an alert module. The method may include a step of receiving a plurality of images from the imaging device and providing the plurality of images via the interface module to the AI module. The method may include a step of evaluating the plurality of images via the AI module to determine the presence or the absence of the spill and providing an output via the AI module to the alert module when the spill has occurred. The method may include a step of providing an output via the AI module to the alert module when the spill has occurred. The method may include a step of performing at least one of providing an alert of the spill, marking an area of the spill, and initiating cleanup of the spill based on the determination.

In certain embodiments, a non-transitory computer-readable medium may store processor instructions for detecting and addressing a spill is provided. When executed by a processor, the processor instructions may cause the processor to receive a plurality of images from an imaging device and provide the plurality of images via an interface module to an AI module. The AI module may include a plurality of neural networks, a secondary layer, and a voting module that may work together to process the image data. The processor instructions may cause the processor to evaluate the plurality of images via the plurality of neural networks to determine a presence or an absence of the spill. The processor instructions may cause the processor to provide separate outputs to at least one of the voting module and the secondary layer based on the presence or absence of the spill. The processor instructions may cause the processor to execute at least one of an ensemble algorithm and the secondary layer based on the separate outputs to generate a single output. The processor instructions may cause the processor to perform at least one of providing an alert of the spill, marking an area of the spill, and initiating cleanup of the spill.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagram illustrating an embodiment of a system for detecting and addressing a spill;

FIG. 2 is a block diagram illustrating another embodiment of a system for detecting and addressing a spill;

FIG. 3 is a block diagram illustrating yet another embodiment of a system for detecting and addressing a spill;

FIG. 4 is an illustration of a system including a mobile robot and imaging device for detecting and addressing a spill;

FIGS. 5a, 5b, 5c, and 5d are illustrations of images depicting a spill;

FIG. 6 is an illustration of a mobile robot and imaging device for detecting and addressing a spill;

FIGS. 7a, 7b, 7c, 7d, 7e, and 7f are illustrations of RGB, thermal, and heatmap images depicting a spill;

FIG. 8a is a block diagram illustrating use of a neural network for spill detection;

FIGS. 8b and 8c are block diagrams illustrating uses of a plurality of neural networks for spill detection;

FIGS. 9a and 9b are a sequence diagrams illustrating embodiments of a system utilizing a secondary layer for detecting and addressing a spill;

FIG. 10 is a flowchart illustrating a training of a neural network for spill detection for a certain floor plan;

FIGS. 11a and 11b provide a flowchart illustrating an embodiment of a method for detecting and addressing a spill;

FIG. 12 provides a flowchart extending from FIGS. 11a and 11b and further illustrates a method for detecting and addressing a spill;

FIG. 13 provides a flowchart extending from FIGS. 11a and 11b and further illustrates a method for detecting and addressing a spill;

FIG. 14 provides a flowchart extending from FIGS. 11a and 11b and further illustrates a method for detecting and addressing a spill; and

FIG. 15 provides a flowchart extending from FIGS. 11a and 11b and further illustrates a method for detecting and addressing a spill.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

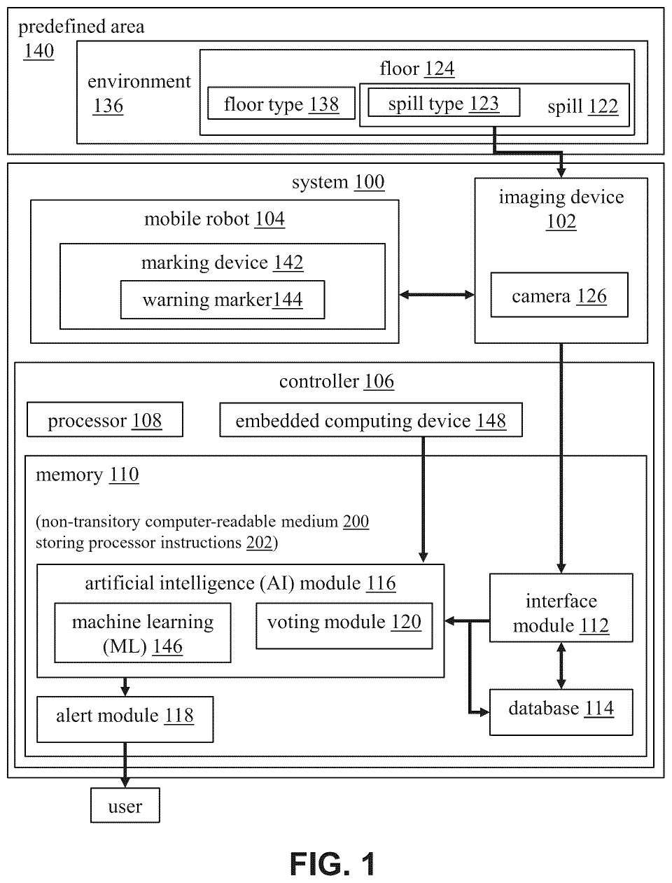

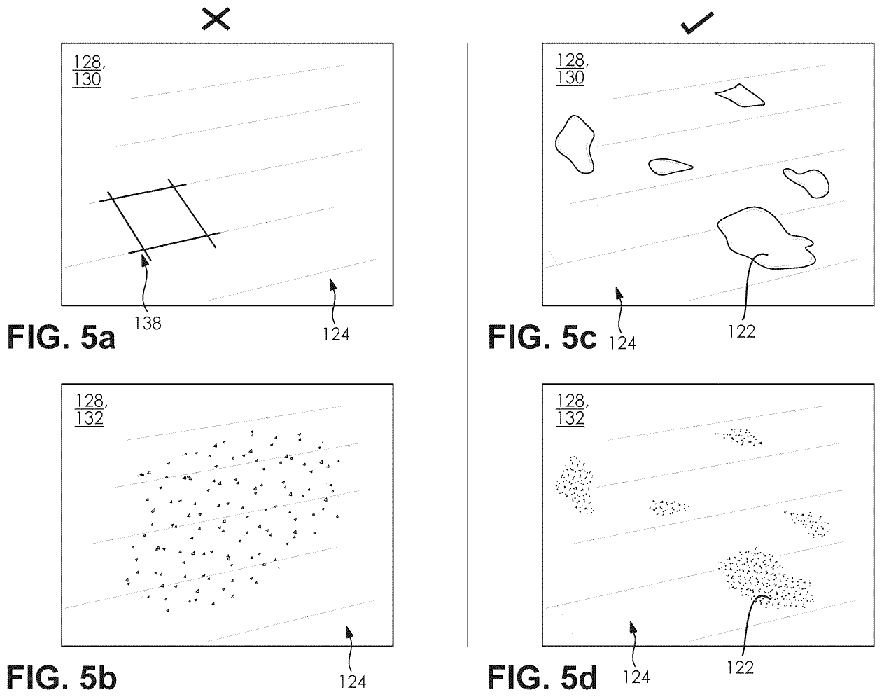

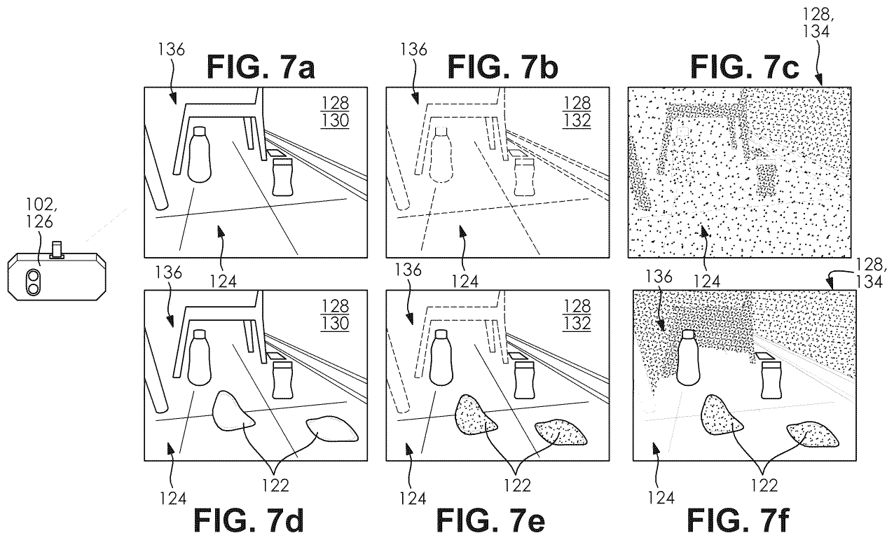

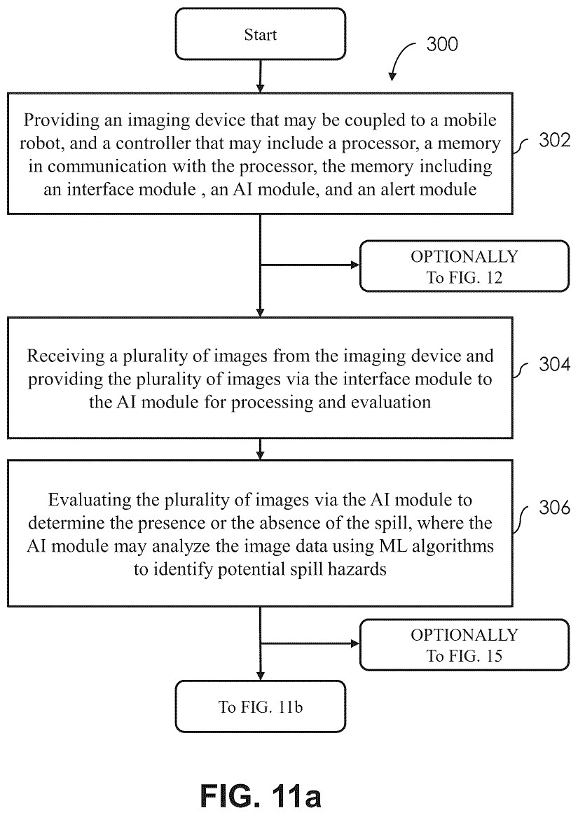

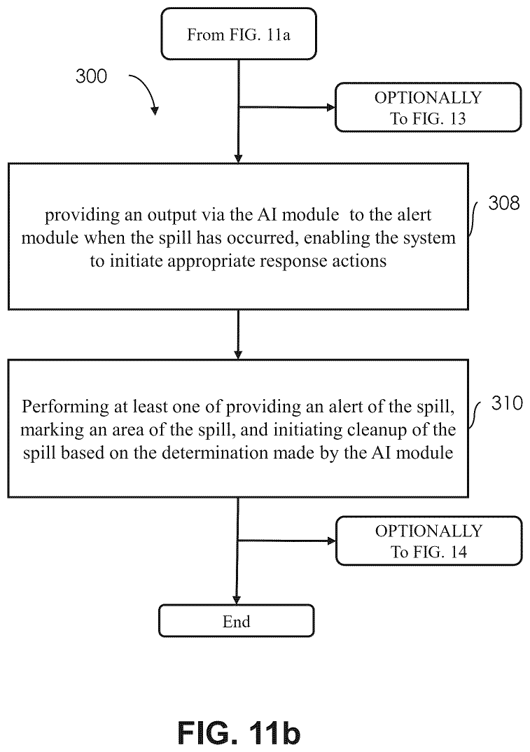

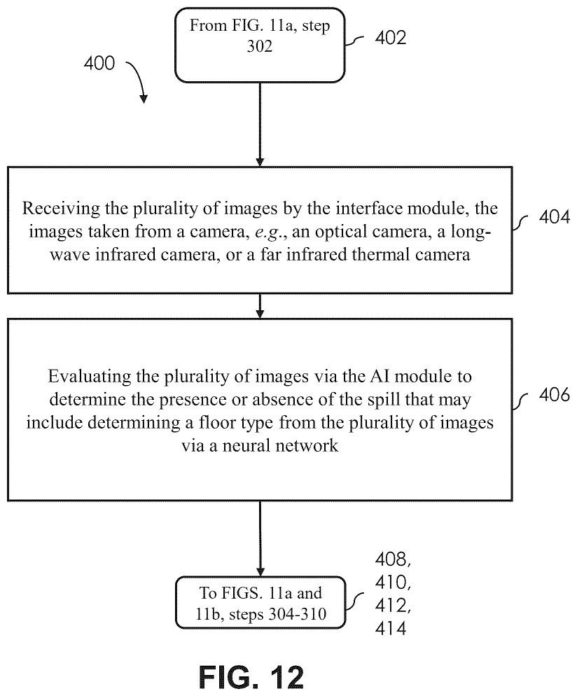

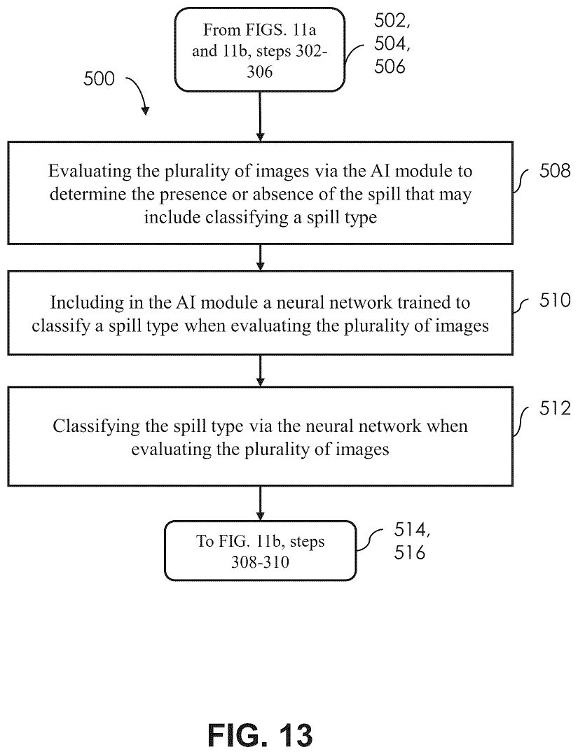

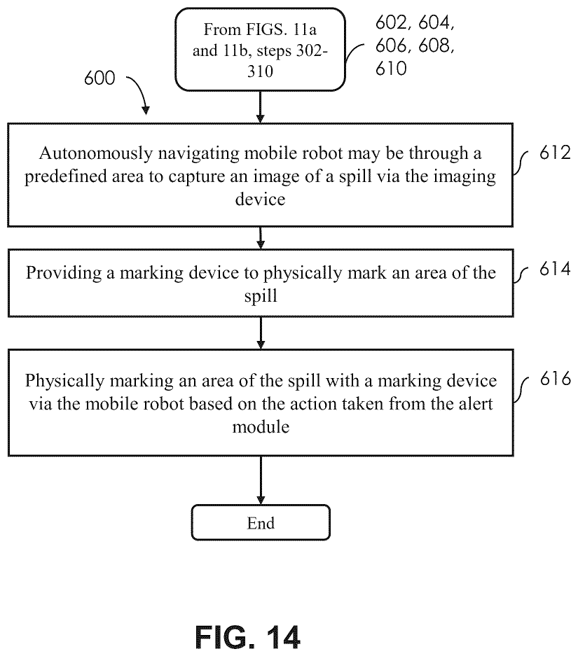

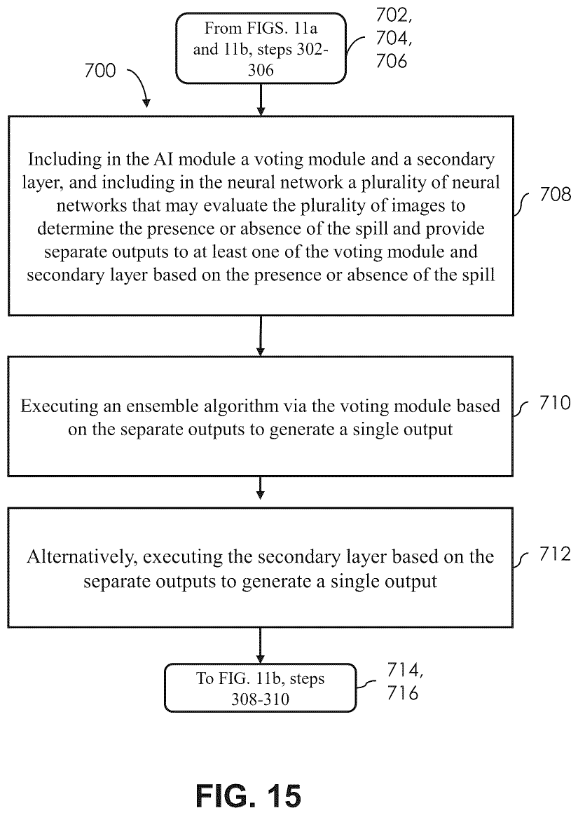

The present technology provides a system 100 and configurations thereof for detecting and addressing a spill, aspects of which are shown generally in accompanying FIGS. 1-10. A method 300 for detecting and addressing a spill is also disclosed, aspects of which are shown in FIGS. 11a and 11b. Another method 400 for detecting and addressing a spill is disclosed in FIG. 12. Another method 500 for detecting and addressing a spill is disclosed in FIG. 13. And another method 600 for detecting and addressing a spill is also disclosed in FIG. 14. Another method 700 for detecting and addressing a spill is further disclosed in FIG. 15.

The system 100 and methods 300, 400, 500, 600, and 700 allow for the detection of liquid spills via artificial intelligence (AI) imaging in order to alert personnel. As shown in FIGS. 1-10, the system 100 may include an imaging device 102 that may be coupled to a mobile robot 104. The system 100 may include a controller 106 including a processor 108, a memory 110 in communication with the processor 108. The memory 110 may include an interface module 112, a database 114, an AI module 116, and an alert module 118. The AI module 116 may include a voting module 120 and a secondary layer 121.

The imaging device 102 may be coupled to the mobile robot 104 and may serve as the primary data collection component for detecting a spill 122 on a floor 124. The imaging device 102 may include multiple types of cameras 126, for example, an optical camera 126, a long-wave infrared camera 126, and/or a far infrared thermal 132 camera 126. The imaging device 102 may capture an image 128, including an RGB 130 image 128, a thermal 132 image 128, or a heatmap 134 image 128. The imaging device 102 may capture one mor more various types of images 128 simultaneously or sequentially, providing comprehensive data of the surrounding environment 136. The imaging device 102 may be positioned to provide optimal viewing angles for detecting spills 122 across various floor types 138, with the capability to process different spill types 123, for example, water, beverages, cleaning solutions, or other fluids. The imaging device 102 may operate in real-time to continuously monitor the environment 136 as the mobile robot 104 navigates through a predefined area 140.

The mobile robot 104 may serve as a mobile platform that carries the imaging device 102 and enables autonomous or guided navigation through an environment 136. For example, the mobile robot 104 may be any robot platform that moves, including industrial, commercial, and residential robot applications that may be adapted for detection of a spill 122. The mobile robot 104 may be equipped with autonomous navigation capabilities that allow the mobile robot 104 to move through predefined areas 140 systematically to capture images 128 in the location of a potential spill 122. The mobile robot 104 may include various types, for example, ground-based wheeled robots, bipedal robots, quadrupedal robots, aerial drone robots, robots suspended from or mounted on walls or ceilings, or other types depending on the specific application requirements. It should be appreciated that the mobile robot 104 may operate continuously in commercial environments 136, providing ongoing surveillance for spills 122 without requiring constant human supervision.

The mobile robot 104 may include a marking device 142 to physically mark an area of a detected spill 122. The marking device 142 may provide a visual indicator at the location of the spill 122 to warn personnel and customers of potential hazards until cleanup operations may be completed. The marking device 142 may utilize a warning marker 144, for example, applying a physical barrier, colored marker, or other visual warning that may be deployed automatically upon detection of the spill 122. The marking device 142 may be integrated with the mobile robot 104 to enable precise positioning of the warning marker 144 at the location of the detected spill 122. The marking device 142 may remain active until the spill 122 has been addressed and the system 100 has been reset to perform normal operations.

The controller 106 may include a processor 108 and a memory 110 in communication with the processor 108, serving as the central processing unit for the spill detection system 100. The controller 106 may manage all computational operations required for image 128 processing, machine learning (ML) 146, and system coordination. The controller 106 may include an embedded computing device 148, for example, a Raspberry Pi® computing platform, an Intel® NUC computing device, an NVIDIA Jetson® computing platform, or an AMD Zynq™ system-on-a-chip, providing GPU or added CPU acceleration for onboard ML 146 processing. The controller 106 may operate in real-time, processing data from an image 128 as it may be received from the imaging device 102 and coordinating with system modules to ensure seamless operation of the spill detection and response processes.

The processor 108 may be disposed on the mobile robot 104 and interface with the imaging device 102. The processor 108 may allow for the execution of ML 146 algorithms and may execute computational tasks required for detection of the spill 122, including processing the image 128, e.g., system control functions. The processor 108 may be selected based on the computational requirements of the ML 146 algorithms of the system 100. It should be appreciated that the processor 108 may handle real-time processing of multiple image 128 streams from the imaging device 102, ensuring that a detection of the spill 122 may be performed without significant delays. The processor 108 may coordinate with the memory 110 to access a stored neural network 150 and data via the database 114 and execute the various processing modules required for operation of the system 100.

The processor 108 may include one or more processors 108 and may process information and execute the various instructions or operations, as described herein. One or more processors 108 may mean a single processor or multiple processors in a single processing unit, e.g., a central processing unit, multiple processing units, a central processing unit and a graphics processing unit, or a central processing unit and a memory manager. For example, the processor 108 may include multiple processors where one processor is capable of executing one or more of the elements described in this disclosure, and a subsequent processor or processors may execute other elements as described herein, capable of executing all elements only in combination. The processor 108 may include hardware, for example, a central processing unit (CPU), a microprocessor, a microcontroller, a system-on-a-chip 100, a digital signal processor (DSPs), field-programmable gate arrays (FPGAs), application-specific integrated circuits (ASICs), and/or a processor based on a multi-core processor architecture. The processor 108 may be optimized for edge computing applications, as a stand-alone processing component or in conjunction with an embedded computing device 148, enabling local processing without requiring constant connectivity to remote servers 152.

The memory 110 may store system modules, neural networks 150, images 128, and other data required for spill 122 detection operations. The memory 110 may contain the interface module 112, AI module 116, alert module 118, and voting module 120, along with associated databases 114 and configuration files. The memory 110 may store pre-trained neural networks 150 that may be fine-tuned for a specific environment 136 and floor type 138 to maximize detection accuracy. The memory 110 may also maintain, for example, operational logs, detection history, and system configuration parameters that may be used for system optimization and maintenance purposes. The memory 110 may include various types of storage including volatile memory for active processing and non-volatile storage for persistent data storage. The memory 110 may include, for example, a semiconductor-based memory device, a magnetic memory device, an optical memory, a fixed memory, and/or a removable memory. For example, the memory 110 may include any combination of random-access memory (RAM), read only memory (ROM), static storage such as a magnetic or optical disk, a hard disk drive (HDD), or any other type of non-transitory machine or computer readable media. The memory 110 may store or otherwise include one or more databases 114.

The interface module 112 may receive the image 128 or a plurality of images 128 from the imaging device 102 and provide the image 128 or plurality of images 128 to the AI module 116 for processing. The interface module 112 may handle all data communication between the imaging device 102 and the processing components of the system 100. The interface module 112 may perform initial image 128 preprocessing operations including format conversion, resolution adjustment, and data validation to ensure that image 128 data may be properly formatted for neural network 150 processing. The interface module 112 may manage multiple image 128 streams simultaneously when the imaging device 102 includes both optical and thermal 132 cameras 126, or optical and heatmap 134 cameras 126, coordinating the timing and synchronization of image 128 data. For example, the interface module 112 may implement buffering and queuing mechanisms to ensure smooth data flow even when processing demands may vary during operation. The interface module 112 may also serve as the point of interaction between a user and the system 100 and interact with hardware including various output 156 devices that may display a representation of the interface module 112 for observation by the user, where such an output 156 device may include, for example, one or more computer screens, speakers, tablet screens, phone screens, consoles, tv screens, or other view/audio ports. In other words, the interface module 112 may include, for example, a graphical user interface that can be displayed in various ways, e.g., via a desktop application, smartphone or mobile application, web interface, or API, and may interface with mobile SMS, social platforms, or messaging applications. The interface module 112 may be intuitive and user-friendly, for example, with custom user preferences and accessibility requirements.

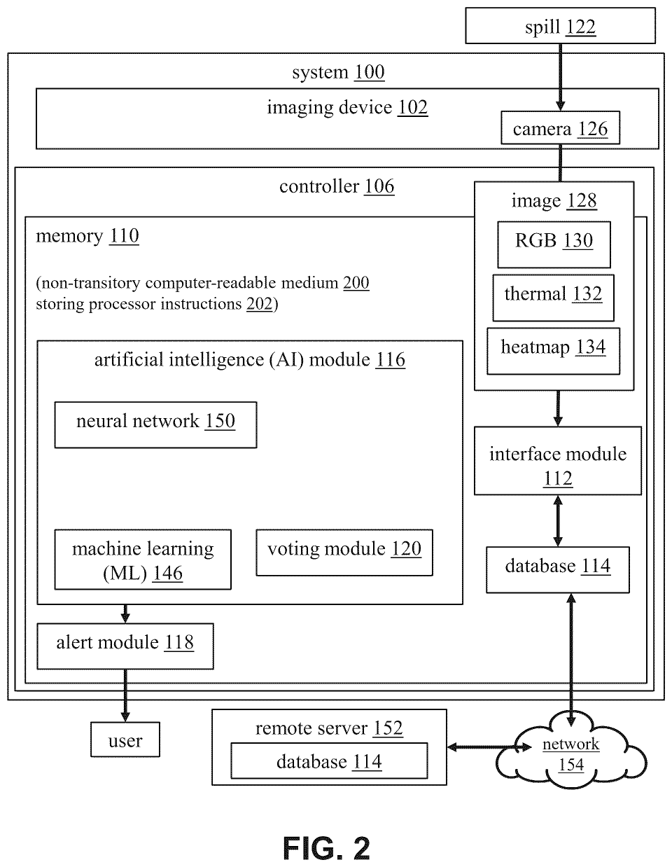

The database 114 may store training data, and operational parameters required for ML 146 operations. As shown in FIG. 2, the database 114 may include storage on a local database 114, remote storage capabilities on a remote server 152 via a network 154, or a combination of local and remote database 114 depending on system 100 requirements and connectivity options. The database 114 may maintain libraries of training images 128 that may be used for fine-tuning neural network 150 models for specific floor types 138 and environmental conditions. The database 114 may store data for historical detection that may be used for system performance analysis and continuous improvement of detection algorithms. The database 114 may also maintain configuration profiles for different residential or commercial environments 136, enabling rapid deployment and adaptation of the system 100 to new locations and predefined areas 140. The database 114 may include, for example, a vector database 114 or vector store for storing feature vectors 162, e.g. flexible, meaning-based, probabilistic numerical representations of data that capture semantic meaning, allowing the system 100 to compare similarities between different types of data. The database 114 may also include a relational database 114, for example, data saved in a structured form, e.g. a structured query language (SQL) table, a comma-separated values (CSV) file, or in JavaScript object notation (JSON), or a JSON-related object or map, or object storage, or other forms of tabular input. The database 114 may also include a general storage database to store, for example, unstructured data such as HTML, text, raw transcripts, chat logs, images 128, or audio files as needed for commercial or personal use. It should be understood that the database 114 may employ a separate or secondary encryption to protect sensitive information, ensuring that the stored data remains secure from external influences.

With reference to FIGS. 1-3 and 8a-10, the AI module 116 may receive the plurality of images 128 from the interface module 112, evaluate the plurality of images 128 to determine a presence or an absence of the spill 122, and provide an output 156 to the alert module when the spill 122 has occurred. The AI module 116 may be capable of classifying different spill types 123 and determining a floor type 138 from the analyzed images 128. The AI module 116 may operate in real-time to provide immediate detection results as images 128 may be processed. The AI module 116 may utilize advanced ML 146 models including neural networks 150 and may implement training methodologies including an ensemble algorithm 158, e.g., max voting, stacking ensemble 160 approaches with a secondary layer 121, and combined RGB 130 and thermal 132 image 128, or RGB 130 and heatmap 134 image 128 processing techniques. The AI module 116 may It should be appreciated that the neural network 150 may process data for both RGB 130 and thermal 132 images 128, or RGB 130 and heatmap 134 images 128 simultaneously, utilizing the advantages of multiple imaging modalities to improve detection reliability.

The AI module 116 may store the feature vectors 162 in the database 114. The AI module 116 may utilize an edge computing by implementing an embedded computing device 148 for onboard ML 146 processing, which may be disposed on the mobile robot 104, or located remotely via a remote server 152 for convenient access and enhanced control. The AI module 116 may process sequences of feature vectors 162 and learn patterns. The AI module 116 may also include, for example, a machine-learning module, allowing the system 100 to utilize various deep learning architectures.

The AI module 116 may utilize separate training of RGB 130 and thermal 132, or RGB 130 and heatmap 134 image 128 datasets with ensemble algorithms 158 including, for example, max voting when both types of cameras 126 may present images 128 to pretrained models simultaneously. Alternatively, the AI module 116 may merge RGB 130 and thermal 132 images 128, or RGB 130 and heatmap 134 images 128 together into a combined image 128 dataset that may be presented to the neural networks 150 as unified inputs. The AI module 116 may feed the images 128 into subsequent layers of the neural network 150 or the secondary layer 121 as required by the system 100 for enhanced training and optimization purposes. A skilled artisan may employ these approaches separately or in combination for spill 122 detection, allowing for optimal performance across different environments 136 and different spill types 123.

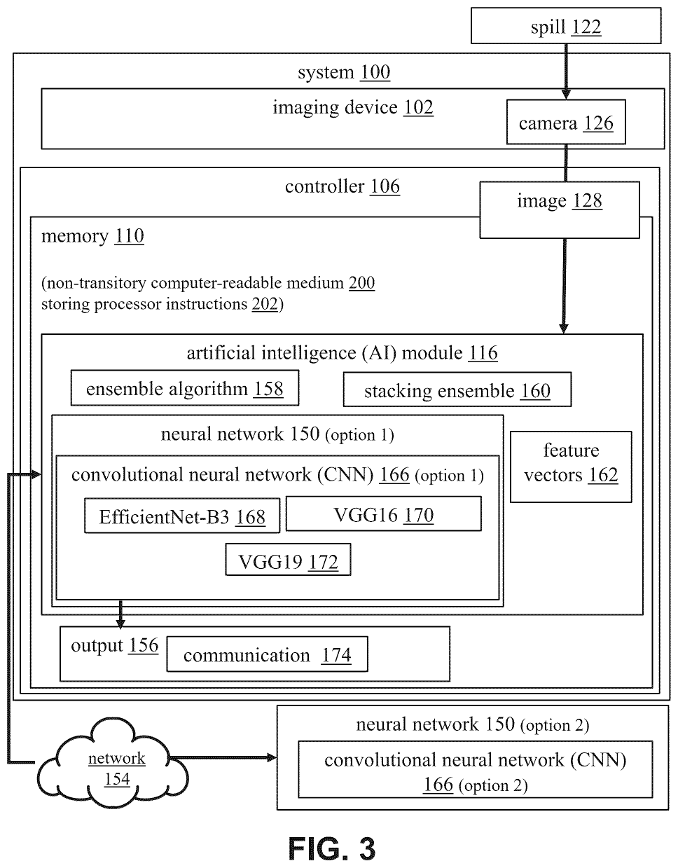

The neural network 150 may be trained to classify spill types 123 when evaluating the plurality of images 128. The neural network 150 may utilize various types of models, including a convolutional neural network (CNN) 166 that may be specifically optimized for spill 122 detection applications. The CNN 166 may be saved locally on the mobile robot 104, as shown in FIG. 3, option 1, or accessed remotely via the network 154, as shown in FIG. 3, option 2. The neural network 150 may be fine-tuned using training data specific to different floor types 138 to maximize detection accuracy across various commercial environments. The AI module 116 may include plurality of neural networks 150 that may evaluate the plurality of images 128 to determine the presence or absence of the spill 122 and provide separate outputs 156 to the voting module 120. The plurality of neural networks 150 may include different architectures such as EfficientNet-B3 168, VGG16 170, and VGG19 172 that may be trained using different methodologies to provide diverse perspectives on spill 122 detection. The plurality of neural networks 150 may operate in parallel to provide simultaneous analysis of image 128 data, enabling rapid detection responses.

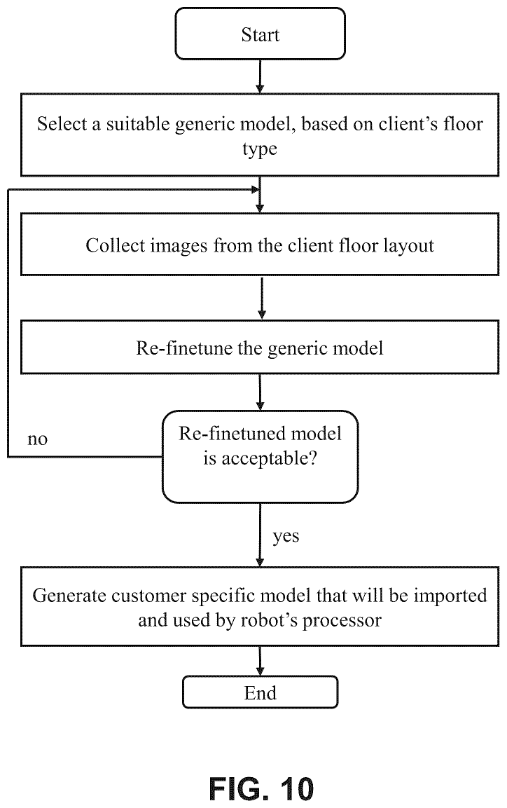

As shown in FIG. 10, the plurality of neural networks 150 may be individually optimized for specific aspects of spill 122 detection, such as different floor types 138 or floor 124 surface characteristics. The plurality of neural networks 150 may be continuously updated and retrained based on operational feedback to maintain optimal performance over time. For example, the system 100 may develop “generic” neural network 150 models for typical floor types 138, including materials such as porcelain, ceramic tile, vinyl plank, sealed concrete, hardwood, engineered wood, and epoxy-coated flooring. For example, the system 100 may train on a plurality of images 128 for a certain floor type 138. The generic neural network 150 model may be trained until the results are acceptable for the certain floor type 138. The generic model, trained for the floor type 138, may be provided to a user to further customize for the layout of a specific predefined area 140. After collecting images 124 from a custom layout for a user, a chosen generic neural network 150 model will be re-finetuned locally or cloud-based via the network 154.

The voting module 120 may receive separate outputs 156 from the plurality of neural networks 150 within the AI module 116 and may execute an ensemble algorithm 158 based on the separate outputs 156 to generate a single output 156 for spill 122 detection decisions. For example, the voting module 120 may implement max voting approaches where multiple pretrained neural network 150 models may be employed simultaneously when both RGB 130 and thermal 132, or RGB 130 and heatmap 134 camera 126 images 128 may be presented to the system 100. The voting module 120 may implement various ensemble methods, e.g., weighted voting schemes that may consider the confidence levels of individual neural network 150 predictions. The voting module 120 may generate a single consolidated output 156 that may be provided to the alert module 118 for initiating appropriate response actions when spills 122 may be detected in the monitored environment 136, improving overall detection accuracy and reduce false positive rates. It should be appreciated that the voting module 120 may generate final detection decisions that may be more reliable than individual neural network 150 outputs 156 alone.

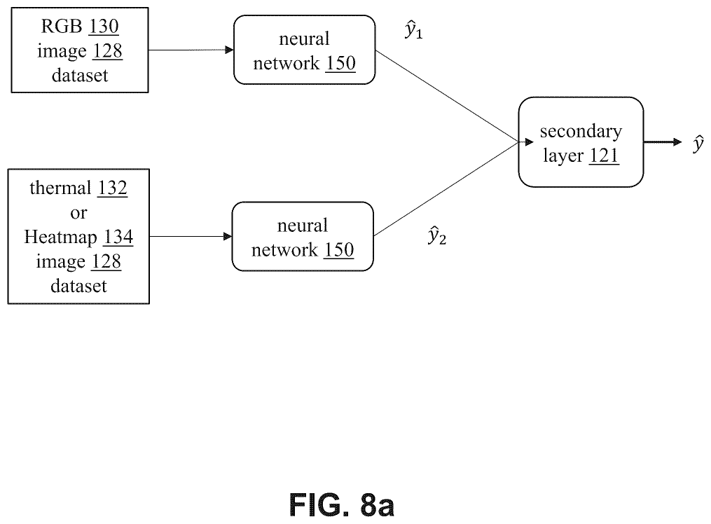

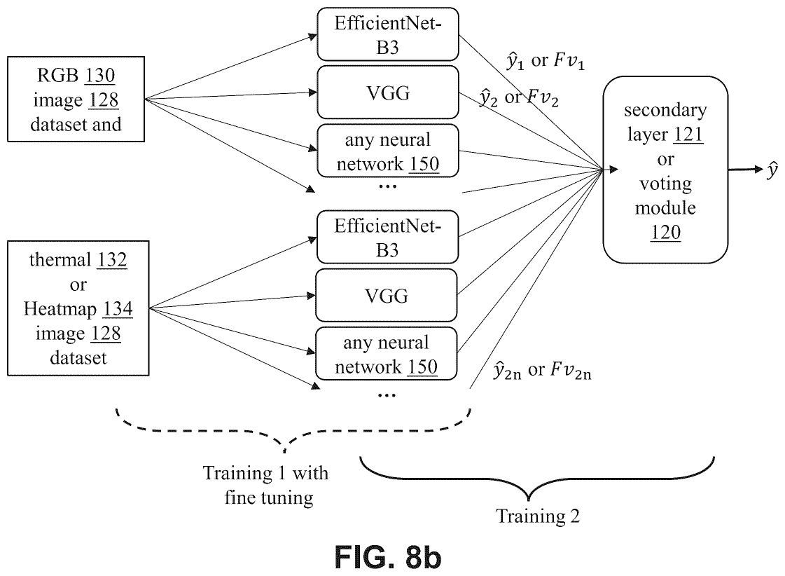

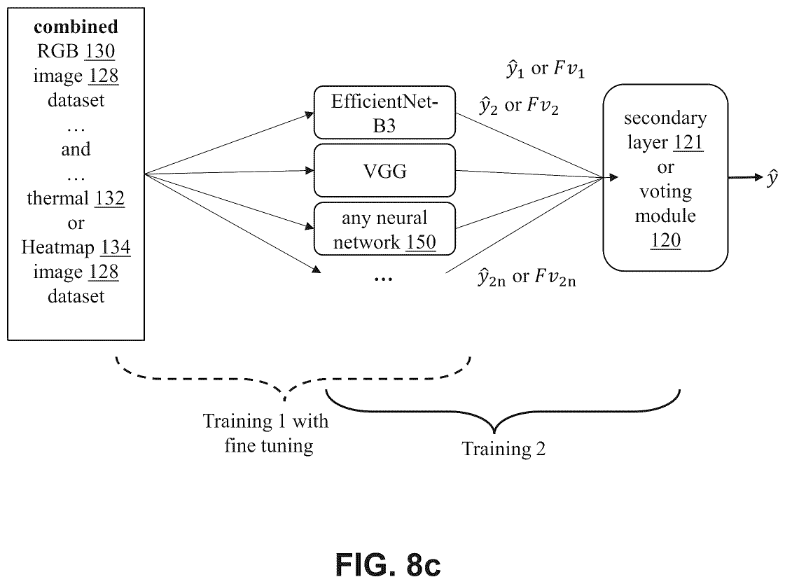

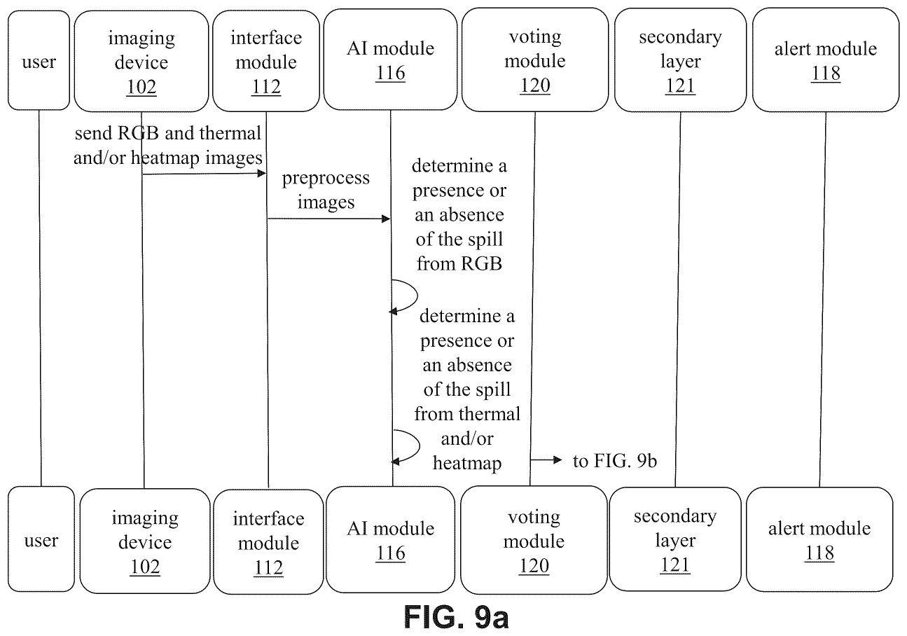

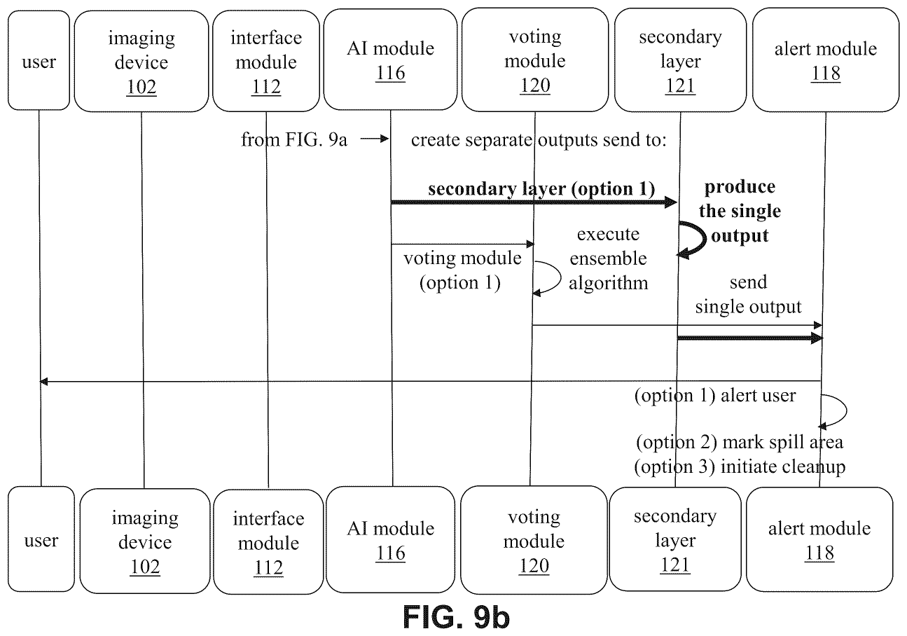

The secondary layer 121 may receive the separate outputs 156 from the plurality of neural networks 150 within the AI module 116, as shown in FIGS. 8a-9b, and may produce the single output 156 for enhanced spill 122 detection accuracy. In other words, the AI module 116 may utilize stacking ensemble 160 concepts by introducing the secondary layer 121, e.g., an additional neural network 150 layer, after the plurality of neural networks 150, performing additional training beyond the initial fine-tuning process and may produce an Fv₁ (e.g., an intermediate feature vector 162) or ŷ (e.g., the predicted output 156 value for a given input), allowing the AI module 116 to produce both feature vectors 162 and model predictions. The secondary layer 121 may work in conjunction with the voting module 120 to provide alternative ensemble processing capabilities that may extend beyond simple voting algorithms. The secondary layer 121 may perform additional training beyond the initial fine-tuning process, utilizing the stacking ensemble 160 to improve overall detection performance. It should be appreciated that the secondary layer 121 may provide an alternative pathway for ensemble decision-making that may complement the voting module 120 functionality, enabling the AI module 116 to utilize multiple approaches for combining neural network 150 outputs 156 to achieve optimal spill 122 detection reliability.

The alert module 118 may receive the output 156 from the AI module 116 and provide an alert of the spill 122, marking an area of the spill 122 with a marking device 142, or initiating cleanup of the spill 122. The alert module 118 may implement multiple notification methods, for example, text messages, or emails to ensure that relevant personnel may be promptly informed of detected spills 122. The alert module 118 may coordinate with the marking device 142 to physically mark detected spill 122 areas, providing immediate visual warning markers 144 to prevent accidents. For example, the alert module 118 may interface with automated cleanup systems or robotic cleaning devices to initiate immediate response actions when a spill 122 may be detected.

The alert module 118 may include a communication 174 that may transmit alerts through various communication channels such as text messages and emails to management personnel. The alert module 118 may, for example, maintain communication logs and response tracking to ensure that spills 122 may be properly addressed and resolved. The communication 174 may include contact information for relevant personnel who may need to respond incidents of a spill 122 in different areas or during different operational periods. The communication 174 may provide detailed information about detected spills 122, e.g., location, time of detection, and spill 122 characteristics to enable appropriate response actions. The communication 174 may trigger escalation procedures to ensure that notifications of a spill 122 may reach responsible personnel even if primary contacts may not be immediately available. It should be understood that the system 100 may maintain a log of the communication 174 for documentation and analysis of response times and effectiveness.

As shown in FIGS. 1-3, a non-transitory computer-readable medium 200 may store processor instructions 202 for detecting and addressing a spill 122 is provided. When executed by a processor 108, the processor instructions 202 may cause the processor 108 to receive a plurality of images 128 from an imaging device 102 and provide the plurality of images 128 via an interface module 112 to an AI module 116. The AI module 116 may include a plurality of neural networks 150, a secondary layer 121, and a voting module 120 that may work together to process the image 128 data. The processor instructions 202 may cause the processor 108 to evaluate the plurality of images 128 via the plurality of neural networks 150 to determine a presence or an absence of the spill 122. The processor instructions 202 may cause the processor 108 to provide separate outputs 156 to at least one of the voting module 120 and the secondary layer 121 based on the presence or absence of the spill 122. The processor instructions 202 may cause the processor 108 to execute at least one of an ensemble algorithm 158 and the secondary layer 121 based on the separate outputs 156 to generate a single output 156. The processor instructions 202 may cause the processor 108 to perform at least one of providing an alert of the spill 122, marking an area of the spill 122, and initiating cleanup of the spill 122.

As shown in FIGS. 11a and 11b, a method 300 for detecting and addressing a spill 122 may be provided. The method 300 may include a step 302 of providing an imaging device 102 that may be coupled to a mobile robot 104, and a controller 106 that may include a processor 108, a memory 110 in communication with the processor 108, the memory 110 including an interface module 112, an AI module 116, and an alert module 118. The method 300 may include a step 304 of receiving a plurality of images 128 from the imaging device 102 and providing the plurality of images 128 via the interface module 112 to the AI module 116 for processing and evaluation. The method 300 may include a step 306 of evaluating the plurality of images 128 via the AI module 116 to determine the presence or the absence of the spill 122, where the AI module 116 may analyze the image 128 data using ML 146 algorithms to identify potential spill 122 hazards. The method 300 may include a step 308 of providing an output 156 via the AI module 116 to the alert module 118 when the spill 122 has occurred, enabling the system 100 to initiate appropriate response actions. The method 300 may include a step 310 of performing at least one of providing an alert of the spill 122, marking an area of the spill 122, and initiating cleanup of the spill 122 based on the determination made by the AI module 116.

As shown in FIG. 12, a method 400 for detecting and addressing a spill 122 may be provided. The method 400 may include step 302 of method 300 (as step 402 respectively). The method 400 may include a step 404 of receiving the plurality of images 128 by the interface module 112. The images 128 may be taken from a camera 126, e.g., an optical camera 126, a long-wave infrared camera 126, or a far infrared thermal 132 camera 126. The method 400 may include a step 406 of evaluating the plurality of images 128 via the AI module 116 to determine the presence or absence of the spill 122 that may include determining a floor type 138 of the floor 124 from the plurality of images 128 via a neural network 150. The imaging device 102 may capture both RGB 130 and thermal 132 images 128 simultaneously, providing comprehensive data from the environment 136 for analysis by the ML 146 algorithms. The neural network 150 may be specifically trained to recognize different floor types 138 to enhance spill 122 detection accuracy across various commercial environments 136. The method 400 may include steps 304-310 of method 300 (as steps 408-414 respectively).

As shown in FIG. 13, a method 500 for detecting and addressing a spill 122 may be provided. The method 500 may include steps 302-306 of method 300 (as steps 502-506 respectively). The method 500 may include a step 508 of evaluating the plurality of images 128 via the AI module 116 to determine the presence or absence of the spill 122 that may include classifying a spill type 123. The method 500 may include a step 510 of including in the AI module 116 a neural network 150 trained to classify a spill type 123 when evaluating the plurality of images 128. The method 500 may include a step 512 of classifying the spill type 123 via the neural network 150 when evaluating the plurality of images 128. For example, the neural network 150 may be capable of distinguishing between different spill types 123 including water, beverages, and other fluids that may be encountered in commercial environments 136. The classification capabilities of the AI module 116 may allow for appropriate response protocols to be initiated based on the specific spill type 123 that may be detected. The method 500 may include steps 308-310 of method 300 (as steps 514-516 respectively).

As shown in FIG. 14, a method 600 for detecting and addressing a spill 122 may be provided. The method 600 may include steps 302-310 of method 300 (as steps 602-610 respectively). The method 600 may include a step 612 autonomously navigating mobile robot 104 may be through a predefined area 140 to capture an image 128 of a spill 122 via the imaging device 102. The method 600 may include a step 614 of providing a marking device 142 to physically mark an area of the spill 122. The method 600 may include a step 616 of physically marking an area of the spill 122 with a marking device 142 via the mobile robot 104 based on the action taken from the alert module 118. The mobile robot 104 may be any robot platform that moves, including industrial, commercial, and residential robot applications that may be adapted for spill 122 detection purposes. The marking device 142 may provide visual indicators, e.g., a warning marker 144, at the location of the spill 122 to warn personnel and customers of potential hazards until cleanup operations may be completed.

As shown in FIG. 15, a method 700 for detecting and addressing a spill 122 may be provided. The method 700 may include steps 302-306 of method 300 (as steps 702-706 respectively). The method 700 may include a step 708 of including in the AI module 116 a voting module 120 and a secondary layer 121, and including in the neural network 150 a plurality of neural networks 150 that may evaluate the plurality of images 128 to determine the presence or absence of the spill 122 and provide separate outputs 156 to at least one of the voting module 120 and the secondary layer 121 based on the presence or absence of the spill 122. The method 700 may include a step 710 of executing an ensemble algorithm 158 via the voting module 120 based on the separate outputs 156 to generate a single output 156. The ensemble algorithms 158 may include max voting approaches where multiple pretrained neural network 150 models may be employed simultaneously when both RGB 130 and thermal 132 camera 126 images 128 may be presented to the AI module 116. The voting module 120 may coordinate outputs 156 from neural networks 150, e.g., CNNs such as EfficientNet-B3 168, VGG16 170, and VGG19 172 that may be trained to provide diverse perspectives on spill 122 detection accuracy. Alternatively, the method 700 may include a step 712 of executing the secondary layer 121 based on the separate outputs 156 to generate a single output 156. The method 700 may include steps 308-310 of method 300 (as steps 714-716 respectively).

The present technology may overcome the limitations of other spill 122 detection approaches that may rely on human intervention and manual processes, which may introduce delays in detection and response times and may depend on staff members to visually identify spills 122 during routine inspections or rely on customers to report hazardous conditions. The present technology may address the problems of other detection systems that may be ill-suited for addressing water spills 122 in commercial environments due to architectural limitations and operational constraints, for example, wall-mounted cameras 126 pointed at potential hazards that may lack the dynamic capabilities required for comprehensive spill 122 detection across large areas. The present technology may solve the challenges of other spill 122 detection systems that may rely primarily on segmentation techniques, i.e., classifying each pixel in an image by dividing the image into different regions based on the features extracted from the image, for detecting edges and object boundaries, which may have potential problems in commercial applications where spills 122 may not be uniform puddles and may not contain adequate volumes of fluid for accurate detection. The present technology may provide enhanced detection accuracy through advanced ML 146 techniques that may utilize multiple imaging modalities simultaneously, offering adaptability for different commercial environments while militating against missed detections or false positives.

### EXAMPLES

Example embodiments of the present technology are provided with reference to the several figures including FIGS. 1-15 enclosed herewith.

### Example 1: Restaurant Spill Detection

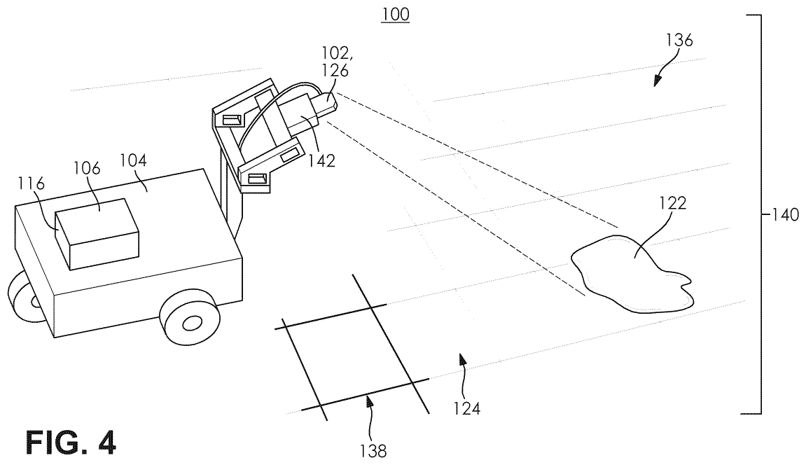

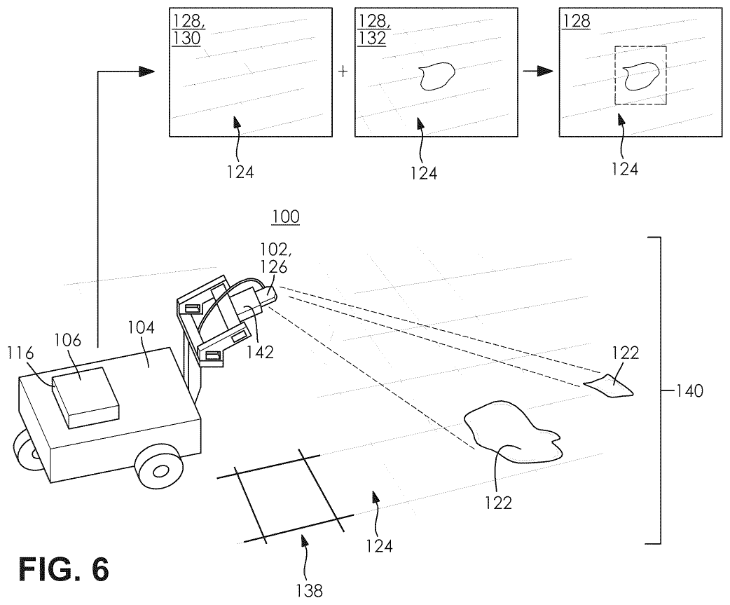

The system 100 may be deployed in a busy restaurant where liquid spills 122 may occur due to food preparation activities and beverage service operations. As shown in FIGS. 4 and 6, the mobile robot 104 may be equipped with an imaging device 102 that may include both an optical camera 126 and a thermal 132 imaging camera 126 to capture comprehensive environmental data as the robot navigates through the restaurant area. The controller 106 may process image 128 data through the processor 108 and memory 110, which may contain the interface module 112, AI module 116, and alert module 118 for real-time spill 122 detection. The imaging device 102 may continuously monitor floor 124 surfaces for water spills 122 from cleaning operations, beverage spills 122 from drink preparation, and other liquid hazards that may create slip and fall risks for customers and restaurant staff.

The interface module 112 may receive a plurality of images 128 from the imaging device 102 and provide the plurality of images 128 to the AI module 116 for evaluation and analysis. The AI module 116 may utilize neural networks 150 including a CNN 166 such as an EfficientNet-B3 168, VGG16 170, or VGG19 172 that may be custom fine-tuned for detecting spills 122 on surface of commercial restaurant floors 124. The neural network 150 may evaluate the plurality of images 128 to determine the presence or absence of spills 122 while also classifying the spill type 123, such as water, cleaning solutions, cooking oil, or beverage liquids that may require different cleanup approaches. The voting module 120 within the AI module 116 may execute ensemble algorithms 158 based on separate outputs 156 from plurality of neural networks 150 to generate a single, reliable output 156 for spill 122 detection decisions.

When a spill 122 is detected, the AI module 116 may provide an output 156 to the alert module 118, which may immediately initiate multiple response actions to address the hazard. The alert module 118 may transmit a communication 174, including notifications, text messages, and emails to restaurant management personnel, providing details about the spill 122 location and spill type 123 for appropriate response. The mobile robot 104 may include a marking device 142 that may physically mark the area of the spill 122 based on output 156 from the alert module 118, creating warning markers 144 to prevent customers and restaurant staff from entering the hazardous area. The system 100 may continue monitoring the marked area until cleanup operations may be completed and the spill 122 hazard may be eliminated.

The mobile robot 104 may autonomously navigate through predefined restaurant areas following established patrol routes that may cover high-risk zones such as beverage preparation areas and food service lines. The system 100 may operate continuously during peak restaurant hours when spill 122 risks may be highest, providing ongoing surveillance without requiring dedicated staff attention. The AI module 116 may be trained to recognize different floor types 138 commonly found in commercial restaurants, including non-slip surfaces, tile floors 124, and rubber matting that may affect spill 122 detection accuracy. The ensemble algorithm 158 approach may provide enhanced detection reliability in challenging restaurant environments 136 where lighting conditions, steam, and food debris may interfere with conventional detection methods.

### Example 2: Airport Environment Spill Detection

The system 100 may be deployed in an airport terminal where liquid spills 122 may occur frequently due to beverage service areas, food courts, and passenger activities throughout the facility. The mobile robot 104 may be equipped with an imaging device 102 that may include both optical cameras 126 and thermal 132 imaging cameras 126 to capture comprehensive environmental data as the robot navigates through high-traffic areas including gate waiting areas, baggage claim zones, and concourse walkways. The controller 106 may process image 128 data through the interface module 112, AI module 116, and alert module 118 for real-time spill 122 detection in the airport environment 136. The imaging device 102 may continuously monitor floor 124 surfaces for water spills 122 from cleaning operations, beverage spills 122 from coffee shops and restaurants, and other liquid hazards that may create slip and fall risks for passengers and airport personnel.

The interface module 112 may receive a plurality of images 128 from the imaging device 102 and provide the plurality of images 128 to the AI module 116 for evaluation and analysis in the airport setting. The AI module 116 may utilize neural networks 150 that may be custom fine-tuned for detecting spills 122 on various airport floor 124 surfaces including polished concrete, carpet, and specialized non-slip materials. The neural network 150 may evaluate the plurality of images 128 to determine the presence or absence of spills 122 while also classifying the spill type 123, such as water, coffee, soft drinks, or cleaning solutions that may require different cleanup approaches in the airport environment 136. The voting module 120 within the AI module 116 may execute ensemble algorithms 158 based on separate outputs 156 from plurality of neural networks 150 to generate a single, reliable output 156 for spill 122 detection decisions despite challenging airport conditions including varying lighting and heavy foot traffic.

When a spill 122 may be detected, the AI module 116 may provide an output 156 to the alert module 118, which may immediately initiate multiple response actions to address the hazard in the airport facility. The alert module 118 may transmit a communication 174, including notifications, text messages, and emails to airport maintenance personnel and facility management, providing details about the spill 122 location and spill type 123 for appropriate response protocols. The mobile robot 104 may include a marking device 142 that may physically mark the area of the spill 122 based on output 156 from the alert module 118, creating warning markers 144 to prevent passengers and airport staff from entering the hazardous area until cleanup operations may be completed. The system 100 may continue monitoring the marked area until cleanup operations may be completed and the spill 122 hazard may be eliminated, ensuring passenger safety throughout the airport terminal.

The mobile robot 104 may autonomously navigate through predefined airport areas 140 following established patrol routes that may cover high-risk zones such as food service areas, restrooms, and gate seating areas where spills 122 may be most likely to occur. The system 100 may operate continuously during peak airport hours when passenger traffic may be highest and risks of spill 122 may be elevated, providing ongoing surveillance without requiring dedicated maintenance staff attention. The AI module 116 may be trained to recognize different floor types 138 commonly found in airport terminals, including various carpet materials, polished stone surfaces, and specialized airport flooring 124 that may affect spill 122 detection accuracy. The ensemble algorithm 158 approach may provide enhanced detection reliability in challenging airport environments 136 where passenger luggage, cleaning equipment, and varying lighting conditions from large windows and artificial sources may interfere with conventional detection methods.

### Example 3: Retail Store Customer Area Monitoring

The system 100 may be implemented in a large retail store where customer spills 122 may occur in aisles, near beverage displays, and in food court areas where immediate detection may be necessary to prevent customer injuries. The mobile robot 104 may blend into the retail environment while carrying the imaging device 102 that may capture both RGB 130 and thermal 132 images 128 of floor 124 surfaces as customers shop throughout the store. The AI module 116 may utilize specialized algorithms that may account for varying lighting conditions, different floor 124 materials, and the presence of shopping carts and customer foot traffic that may complicate spill 122 detection. The system 100 may operate during store hours when customer safety may be the primary concern, requiring discrete operation that may not interfere with the shopping experience.

The imaging device 102 may process images 128 from optical cameras 126 and thermal 132 cameras 126 simultaneously, providing the interface module 112 with comprehensive data about potential spill 122 hazards in customer areas. The interface module 112 may handle multiple image 128 streams and provide the plurality of images 128 to the AI module 116, which may be specifically trained to detect beverage spills 122, melted ice cream, and other liquid hazards common in retail environments. The AI module 116 may include a plurality of neural networks 150 that may evaluate floor types 138 ranging from polished concrete to carpeted areas, ensuring accurate detection across diverse retail floor 124 surfaces. The voting module 120 may coordinate outputs 156 from different neural network 150 architectures to detect a spill 122 even in challenging retail environments with varying lighting and surface conditions.

The alert module 118 may provide immediate notifications to store management and cleaning staff when spills 122 may be detected in customer areas. The notification system 100 may include text messages to mobile devices carried by floor 124 supervisors and emails to store management, ensuring rapid response to potential safety hazards. The mobile robot 104 may include a marking device 142 that may deploy temporary warning markers 144 such as warning signs or barriers around spill 122 areas, alerting customers to avoid the hazardous location until cleanup may be completed. The alert module 118 may also coordinate with store announcement systems to provide audio warnings in the affected area, enhancing customer safety measures.

The mobile robot 104 may follow predetermined patrol routes that may cover high-traffic customer areas including main aisles, checkout areas, and food service locations where spills 122 may be most likely to occur. The AI module 116 may be trained to distinguish between actual spills 122 and common retail floor 124 markings, price tags, or merchandise that may create false positive detections. The system 100 may maintain operational logs that may track spill 122 incidents, response times, and cleanup effectiveness to help store management improve safety protocols and identify high-risk areas. It should be appreciated that the ensemble algorithm 158 approach may provide enhanced accuracy in retail environments where customer movement, shopping cart wheels, and varying merchandise displays may create complex detection challenges.

### Example 4: Hospital Corridor Safety Monitoring

The system 100 may be deployed in hospital corridors and patient care areas where liquid spills 122 may pose safety risks to patients, visitors, and medical staff who may be moving quickly during emergency situations. The mobile robot 104 may be equipped with medical-grade imaging device 102 components that may operate in healthcare environments while maintaining infection control standards and noise level requirements. The AI module 116 may utilize neural network 150 training that may account for medical equipment, wheelchairs, gurneys, and other hospital-specific environmental factors that may affect spill 122 detection accuracy. The system 100 may operate continuously to provide round-the-clock monitoring in healthcare facilities where patient safety may be paramount and immediate response to hazards may be required.

The imaging device 102 may capture images 128 using both optical and thermal 132 cameras 126 that may detect various spill types 123 including water from cleaning operations, beverage spills 122 in waiting areas, and medical fluid spills 122 that may require specialized cleanup procedures. The interface module 112 may process image 128 data and provide the plurality of images 128 to the AI module 116, which may be trained to recognize different floor types 138 of hospital floor surfaces, e.g., linoleum, rubber, and specialized medical flooring 124 materials. The AI module 116 may include neural networks 150 that may classify a spill type 123 to determine appropriate response protocols, distinguishing between routine water spills 122 and potentially hazardous medical fluid spills 122 that may require specialized cleanup teams. The voting module 120 may execute ensemble algorithms 158 that may provide highly reliable detection results necessary for healthcare environments where false alarms may disrupt patient care operations.

The alert module 118 may be integrated with hospital communication systems to provide immediate notifications to housekeeping staff, nursing supervisors, and facility management when a spill 122 may be detected. The notification system 100 may include priority levels that may escalate alerts based on spill location and spill type 123, ensuring that spills 122 in patient care areas may receive immediate attention while routine spills 122 in administrative areas may follow standard response protocols. The mobile robot 104 may include a marking device 142 that may deploy medical-grade warning barriers around detected spill 122 areas, preventing patient and staff access until appropriate cleanup may be completed. The alert module 118 may also interface with hospital incident reporting systems to maintain documentation required for healthcare facility safety compliance.

The mobile robot 104 may navigate through hospital corridors following routes that may avoid patient care activities while providing comprehensive coverage of high-risk areas including emergency department entrances, cafeteria areas, and patient room corridors. The AI module 116 may be specifically trained to operate in healthcare environments where medical equipment, patient mobility devices, and varying lighting conditions may create unique detection challenges. The system 100 may maintain detailed operational records that may support healthcare facility accreditation requirements and provide data for safety improvement initiatives. The ensemble algorithm 158 approach may provide the high level of detection accuracy required in healthcare settings where patient safety may depend on immediate identification and response to potential slip and fall hazards.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A system for detecting and addressing a spill, the system comprising:
an imaging device configured to be coupled to a mobile robot; and
a controller including a processor, a memory in communication with the processor, the memory including an interface module, an artificial intelligence (AI) module, and an alert module;
wherein:
the interface module is configured to receive a plurality of images from the imaging device and provide the plurality of images to the AI module;
the AI module is configured to receive the plurality of images from the interface module, evaluate the plurality of images to determine a presence or an absence of the spill, and provide an output to the alert module when the spill has occurred; and
the alert module is configured to receive the output from the AI module and perform at least one of providing an alert of the spill, marking an area of the spill, and initiating cleanup of the spill.

2. The system of claim 1, wherein the imaging device includes a member selected from a group consisting of an optical camera, a long-wave infrared camera, a far infrared thermal camera, and combinations thereof.

3. The system of claim 1, wherein the alert module is further configured to transmit a notification of the spill, the notification including a member selected from a group consisting of a text message, an email, and combinations thereof.

4. The system of claim 1, wherein the AI module is further configured to classify a spill type based on the plurality of images.

5. The system of claim 1, wherein the AI module includes a neural network.

6. The system of claim 5, wherein the neural network is configured to determine a floor type from the plurality of images.

7. The system of claim 5, wherein the neural network includes a convolutional neural network (CNN) to evaluate the plurality of images, the CNN selected from a group consisting of an EfficientNet-B3, a VGG16, a VGG19, and combinations thereof.

8. The system of claim 5, wherein:
the AI module includes a voting module;
the neural network includes a plurality of neural networks configured to evaluate the plurality of images to determine the presence or absence of the spill and provide separate outputs to the voting module based on the presence or absence of the spill; and
the voting module is configured to execute an ensemble algorithm based on the separate outputs to generate a single output.

9. A mobile robot comprising the system of claim 1.

10. The system of claim 9, wherein the mobile robot includes a marking device to physically mark an area of the spill based on the output from the alert module.

11. The system of claim 1, wherein:
the imaging device includes a member selected from a group consisting of an optical camera, a long-wave infrared camera, a far infrared thermal camera, and combinations thereof;
the AI module includes a neural network and a voting module,
wherein:
the neural network includes a plurality of neural networks, the plurality of neural networks including a convolutional neural network (CNN) to evaluate the plurality of images, the CNN selected from a group consisting of an EfficientNet-B3, a VGG16, a VGG19, and combinations thereof, the plurality of neural networks configured to:
evaluate the plurality of images to determine the presence or absence of the spill,
determine a floor type from the plurality of images,
classify a spill type based on the plurality of images, and
provide separate outputs to the voting module based on the presence or absence of the spill, and
the voting module is configured to execute an ensemble algorithm based on the separate outputs to generate a single output;
the alert module is further configured to transmit a notification of the spill, the notification including a member selected from a group consisting of a text message, an email, and combinations thereof; and
the mobile robot includes a marking device to physically mark an area of the spill based on the output from the alert module.

12. A method for detecting and addressing a spill, the method comprising:
providing an imaging device configured to be coupled to a mobile robot, and a controller including a processor, a memory in communication with the processor, the memory including an interface module, an artificial intelligence (AI) module, and an alert module;
wherein:
the interface module is configured to receive a plurality of images from the imaging device and provide the plurality of images to the AI module,
the AI module is configured to receive the plurality of images from the interface module, evaluate the plurality of images to determine a presence or an absence of the spill, and provide an output to the alert module when the spill has occurred, and
the alert module is configured to receive the output from the AI module and perform at least one of providing an alert of the spill, marking an area of the spill, and initiating cleanup of the spill;
receiving a plurality of images from the imaging device and providing the plurality of images via the interface module to the AI module;
evaluating the plurality of images via the AI module to determine the presence or the absence of the spill;
providing an output via the AI module to the alert module when the spill has occurred; and
performing at least one of providing an alert of the spill, marking an area of the spill, and initiating cleanup of the spill.

13. The method of claim 12, wherein receiving the plurality of images by the interface module includes processing a member selected from a group consisting of an optical camera, a long-wave infrared camera, a far infrared thermal camera, and combinations thereof.

14. The method of claim 12, wherein evaluating the plurality of images via the AI module to determine the presence or absence of the spill includes classifying a spill type.

15. The method of claim 12, wherein the mobile robot is configured to autonomously navigate through a predefined area, and the method further comprises autonomously navigating the mobile robot through a predefined area to capture an image of a spill via the imaging device.

16. The method of claim 15, wherein the mobile robot includes a marking device to physically mark an area of the spill based on the output from the alert module, and the method further comprises physically marking the area of the spill via the marking device.

17. The method of claim 12, wherein the AI module includes a neural network trained to classify a spill type when evaluating the plurality of images, and the method further comprises classifying the spill type via the neural network when evaluating the plurality of images.

18. The method of claim 17, wherein evaluating the plurality of images via the AI module to determine the presence or absence of the spill includes determining a floor type from the plurality of images via the neural network.

19. The method of claim 17, wherein:
the AI module includes a voting module and a secondary layer;
the neural network includes a plurality of neural networks configured to evaluate the plurality of images to determine the presence or absence of the spill and provide separate outputs to the voting module based on the presence or absence of the spill;
the voting module is configured to execute an ensemble algorithm based on the separate outputs to generate a single output;
the secondary layer is configured to receive the separate outputs and produce the single output; and
the method further comprises:
evaluating the plurality of images via the plurality of neural networks to determine the presence or absence of the spill;
providing separate outputs from each neural network to at least one of the voting module and the secondary layer based on the presence or absence of the spill; and
executing at least one of an ensemble algorithm or the secondary layer based on the separate outputs to generate a single output.

20. A non-transitory computer-readable medium storing instructions for detecting and addressing a spill that, when executed by a processor, cause the processor to:
receive a plurality of images from an imaging device and provide the plurality of images via an interface module to an artificial intelligence (AI) module, the AI module including a plurality of neural networks, a secondary layer, and a voting module;
evaluate the plurality of images via the plurality of neural networks to determine a presence or an absence of the spill;
provide separate outputs to at least one of the voting module or and secondary layer based on the presence or absence of the spill;
execute at least one of an ensemble algorithm and the secondary layer based on the separate outputs to generate a single output; and
perform at least one of providing an alert of the spill, marking an area of the spill, and initiating cleanup of the spill.
